(19) United States
(12) Patent Application Publication
(10) Pub. No.: US 2026/0204162 A1
(43) Pub. Date: Jul. 16, 2026

(54) Method and Device for the Automated Adjustment of the Driving Speed of a Motor Vehicle

(71) Applicant: Bayerische Motoren Werke Aktiengesellschaft, Muenchen (DE)

(72) Inventor: Patrick SAUERMANN, Augsburg (DE)

(21) Appl. No.: 19/445,773

(22) Filed: Jan. 12, 2026

(30) Foreign Application Priority Data
Jan. 13, 2025 (DE) 10 2025 100 972.4

(51) Int. Cl. G08G 1/00; B60W 30/09; B60W 30/095; B60W 30/16; B60W 30/165; B60W 30/18; B60W 60/00

(52) U.S. Cl. CPC G08G 1/22; B60W 30/09; B60W 30/0956; B60W 30/162; B60W 30/165; B60W 30/18163; B60W 60/0015; B60W 2555/20; B60W 2720/10

(57) ABSTRACT

A device for the automated longitudinal guidance of a motor vehicle is described. The device is configured to cause the motor vehicle to have a driving speed during convoy travel that is equal to or less than a convoy travel maximum speed. The device is also configured to detect a transition of the motor vehicle from convoy travel to free travel and, in response to the detection, to cause the driving speed of the motor vehicle to be reduced, during the transition from convoy travel to free travel, to a driving speed equal to or less than a free travel maximum speed, the free travel maximum speed being less than the convoy travel maximum speed.

### CROSS REFERENCE TO RELATED APPLICATION

This application claims priority under 35 U.S.C. §119 from German Patent Application No. DE 10 2025 100 972.4, filed January 13, 2025, the entire disclosure of which is herein expressly incorporated by reference.

### BACKGROUND AND SUMMARY

The present disclosure relates to a method and a corresponding device which are designed to automatically adjust the driving speed of a motor vehicle.

A vehicle may be designed to be guided longitudinally and/or laterally in an automated manner. The automated longitudinal and/or lateral guidance may possibly be effected with such a high degree of automation that the driving operation of the vehicle does not have to be monitored by the driver of the vehicle.

The driving system for the automated longitudinal and/or lateral guidance of the vehicle may be designed to independently determine the driving speed of the vehicle. The maximum speed used can depend on the range with which objects ahead can be reliably detected based on the sensor data captured by the one or more environmental sensors of the vehicle. This sensor-related maximum speed can vary depending on the design of the one or more environmental sensors.

The present disclosure relates to enabling the highest possible maximum speed for the automated longitudinal guidance of a motor vehicle.

This object is achieved by aspects of the present disclosure. Advantageous embodiments are described herein.

One aspect describes a device for the automated longitudinal guidance of a motor vehicle. The device may be designed to effect the longitudinal guidance with a degree of automation according to SAE level 3 or higher. The motor vehicle can be guided longitudinally and, if necessary, laterally in an automated manner within a certain lane. The automated longitudinal guidance can be effected using a speed and/or distance controller.

The device is configured to cause the motor vehicle to have a driving speed during convoy travel that is always equal to or less than a convoy travel maximum speed. Convoy travel may be present, for example, if the motor vehicle has a leading vehicle traveling in front (directly in the same lane) within a convoy travel distance range (directly) ahead (of the vehicle). On the other hand, there may be no convoy travel and possibly free travel instead if the motor vehicle does not have a leading vehicle traveling in front within the convoy travel distance range ahead. The convoy travel distance range may have been determined in advance. Alternatively or additionally, the device may be configured to determine the convoy travel distance range based on the driving speed of the motor vehicle and/or based on the convoy travel maximum speed and/or based on the free travel maximum speed (mentioned below).

The leading vehicle traveling in front can be detected based on the sensor data from one or more environmental sensors (e.g. one or more cameras, one or more radar sensors and/or one or more lidar sensors) of the motor vehicle. Furthermore, the distance and/or the driving speed of the leading vehicle can be determined based on the sensor data from one or more environmental sensors of the motor vehicle.

The device may be configured to cause the motor vehicle to be guided longitudinally in an automated manner with a target distance (possibly determined by the user of the motor vehicle) behind the leading vehicle during convoy travel, in particular using a distance controller, in particular as long as the driving speed of the leading vehicle is equal to or less than the convoy travel maximum speed. Alternatively or additionally, the device may be configured to cause the driving speed of the motor vehicle to always be equal to or less than the convoy travel maximum speed during convoy travel, in particular using a speed controller, if, in particular as long as and/or as soon as, the leading vehicle has a driving speed greater than the convoy travel maximum speed (and as long as the leading vehicle is still in the convoy travel distance range).

The device is further configured to detect (based on the sensor data from the one or more environmental sensors) a transition of the motor vehicle from convoy travel to (directly subsequent) free travel. The transition may have a certain transition type, e.g. a lane change of the leading vehicle, a turning maneuver of the leading vehicle or an acceleration maneuver of the leading vehicle. Examples of transition types for the transition from convoy travel to free travel are:

one or more transition types for a lane change of the leading vehicle to a neighboring lane, in particular a transition type for a lane change:

of an automobile traveling in front;

of a truck traveling ahead;

of a motorcycle traveling ahead; and/or

of a bus traveling ahead; and/or

one or more transition types for a turning maneuver of the leading vehicle (e.g. a transition type for the above-mentioned vehicle types); and/or

a transition type in which the leading vehicle (e.g. due to an acceleration) has a driving speed greater than the convoy travel maximum speed, with the result that the leading vehicle is at an increasingly large distance from the motor vehicle until the leading vehicle finally leaves the convoy travel distance range ahead (and as a result the transition to free travel takes place).

The transition from convoy travel to free travel may have a certain transition period (e.g. between 0.5 and 2 seconds). The transition period may depend on the transition type of the transition.

The device may be configured to cause, in response to the detection, the driving speed of the motor vehicle to be reduced, during the transition (in particular during the transition period of the transition) from convoy travel to free travel, to a driving speed equal to or less than a free travel maximum speed, the free travel maximum speed being less than the convoy travel maximum speed.

The free travel maximum speed may be dependent on the range with which an object ahead can be detected based on sensor data from one or more environmental sensors of the motor vehicle. The range can in turn depend on the technical design of the one or more environmental sensors.

The convoy travel maximum speed can be greater than the free travel maximum speed (exactly) by a (specific) speed delta. The speed delta may depend on:

the transition duration for the transition of the motor vehicle from convoy travel to free travel; and/or

the transition deceleration with which the motor vehicle is decelerated during the transition from convoy travel to free travel.

The device may be configured in particular to cause the driving speed of the motor vehicle to be reduced, in particular using the speed controller, during the transition period of the transition from convoy travel to free travel, from an initial speed exceeding the free travel maximum speed to the free travel maximum speed (such that the driving speed of the motor vehicle corresponds to the free travel maximum speed following the transition period). In addition, the device may be configured to cause the driving speed of the motor vehicle to always be equal to or less than the free travel maximum speed during subsequent free travel, in particular using the speed controller. In particular, the free travel maximum speed can be used as the target speed of the speed controller.

A description is therefore given of a device which makes it possible to use the transition period of a transition from convoy travel to directly subsequent free travel to decelerate the motor vehicle to the sensor-related free travel maximum speed, such that the motor vehicle can be guided longitudinally in an automated manner during the preceding convoy travel with a driving speed which exceeds the free travel maximum speed. This makes it possible to effect particularly comfortable (in particular fast) and safe automated longitudinal guidance of the motor vehicle.

The device may be configured to detect an object ahead during free travel, in particular during directly subsequent free travel. Furthermore, the device may be configured to cause the motor vehicle to be decelerated at least temporarily (or permanently until standstill) with a (relatively large) object deceleration in response to the detection of the object. The absolute value of the object deceleration may be equal to or greater than 4 m/s².

Furthermore, the device may be configured to reduce the driving speed during the transition from convoy travel to free travel with a deceleration that is always equal to or less than the transition deceleration. The absolute value of the transition deceleration is preferably less than the object deceleration, in particular by a factor of 2 or more. For example, the absolute value of the transition deceleration may be equal to or less than 2 m/s².

By causing a relatively low transition deceleration for the transition from convoy travel to free travel and a relatively high object deceleration for the deceleration in response to a detected object, particularly comfortable and safe automated longitudinal guidance of the motor vehicle can be effected.

The device may be configured to determine one or more current ambient conditions in the (direct) surroundings of the motor vehicle, which have an influence on the range with which an object ahead can be detected based on sensor data from the one or more environmental sensors of the motor vehicle. Examples of ambient conditions are:

a weather condition in the surroundings of the motor vehicle; and/or

a lighting situation in the surroundings of the motor vehicle.

Furthermore, the device may be configured to determine the free travel maximum speed and/or the convoy travel maximum speed based on the one or more ambient conditions. By taking into account the respective current ambient conditions when determining the free travel maximum speed and/or the convoy travel maximum speed, the comfort and/or safety of the automated longitudinal guidance can be increased further.

The device may be configured to select (based on the sensor data from the one or more environmental sensors) the transition type of the transition from convoy travel to free travel from the multiplicity of different (predefined) transition types. The convoy travel maximum speed, in particular the speed delta with which the convoy travel maximum speed exceeds the free travel maximum speed, can then be determined based on the selected transition type. For this purpose, if necessary, use may be made of characteristic data that respectively indicate the associated speed delta for the multiplicity of different transition types. The characteristic data may have been determined in advance. This allows the comfort and/or safety of the automated longitudinal guidance to be increased further.

The device may be configured to determine (based on the sensor data from the one or more environmental sensors) the vehicle type of the leading vehicle from a multiplicity of different (predefined) vehicle types. Examples of vehicle types are:

an automobile;

a truck;

a motorcycle; and/or

a bus.

The convoy travel maximum speed, in particular the speed delta with which the convoy travel maximum speed exceeds the free travel maximum speed, can then be determined based on the determined vehicle type of the leading vehicle. For this purpose, if necessary, use may be made of characteristic data that respectively indicate the associated speed delta for the multiplicity of different vehicle types. The characteristic data may have been determined in advance. This allows the comfort and/or safety of the automated longitudinal guidance to be increased further.

A further aspect describes a (road) motor vehicle (in particular an automobile or a truck or a bus or a motorcycle) that comprises the device described in this document.

A further aspect describes a method for the automated longitudinal guidance of a motor vehicle. The method comprises causing the motor vehicle to have a driving speed during convoy travel that is always equal to or less than a convoy travel maximum speed. Furthermore, the method comprises detecting a transition of the motor vehicle from convoy travel to free travel. The method also comprises causing, in response to the detection, the driving speed of the motor vehicle to be reduced, during the transition from convoy travel to free travel, to a driving speed equal to or less than a free travel maximum speed, the free travel maximum speed being less than the convoy travel maximum speed. The method may also comprise causing the motor vehicle to have a driving speed during free travel that is always equal to or less than the free travel maximum speed.

It should be noted that the aspects described in connection with the device can also be applied as corresponding method features to the method.

A further aspect describes a software (SW) program. The SW program may be configured to be executed on a processor (for example on a controller of a vehicle) and thereby to carry out the method described in this document.

A further aspect describes a storage medium. The storage medium may comprise an SW program that is configured to be executed on a processor and thereby to carry out the method described in this document.

Within the scope of the document, the term “automated driving” is understood as driving with automated longitudinal and/or lateral guidance. Automated driving can involve, for example, driving on the freeway for a longer period of time or driving for a limited period of time during parking. The term “automated driving” comprises automated driving with any degree of automation. Examples of degrees of automation are assisted, partially automated, highly automated, fully automated and autonomous driving (with an increasing degree of automation). The above-mentioned five degrees of automation correspond to SAE levels 1 to 5 of the SAE J3016 (SAE - Society of Automotive Engineering) standard. In assisted driving (SAE level 1), the system performs the longitudinal or lateral guidance in certain driving situations. In partially automated driving (SAE level 2), the system takes over the longitudinal and lateral guidance in certain driving situations, wherein the driver must permanently monitor the system like in assisted driving. In highly automated driving (SAE level 3), the system takes over the longitudinal and lateral guidance in certain driving situations without the driver having to permanently monitor the system; however, the driver must be able to take over the vehicle guidance in a certain time on request by the system. In fully automated driving (SAE level 4), the system takes over the vehicle guidance in certain driving situations, even if the driver does not react to a request for intervention, so that the driver is omitted as a fallback level. In autonomous driving (SAE level 5), the system can perform all aspects of the dynamic driving task under any road and ambient conditions, which are also controlled by a human driver.

The measures described in this document relate in particular to a vehicle designed according to SAE level 3 or higher.

It should be noted that the methods, devices and systems described in this document may be used both on their own and in combination with other methods, devices and systems described in this document. Furthermore, any aspects of the methods, devices and systems described in this document may be combined with one another in a wide variety of ways. The features disclosed herein may in particular be combined with one another in a wide variety of ways. Furthermore, features in parentheses should be understood as optional features.

The present disclosure is described in more detail below with reference to exemplary embodiments.

Other objects, advantages and novel features of the present disclosure will become apparent from the following detailed description of one or more preferred embodiments when considered in conjunction with the accompanying drawings.

### BRIEF DESCRIPTION OF THE DRAWINGS

FIG. 1a shows exemplary components of a vehicle;

FIG. 1b shows an exemplary detection range of the one or more environmental sensors of a vehicle;

FIG. 2 shows an exemplary transition of the vehicle from convoy travel to free travel; and

FIG. 3 shows a flowchart of an exemplary method for adjusting the driving speed of a vehicle.

### DETAILED DESCRIPTION OF THE DRAWINGS

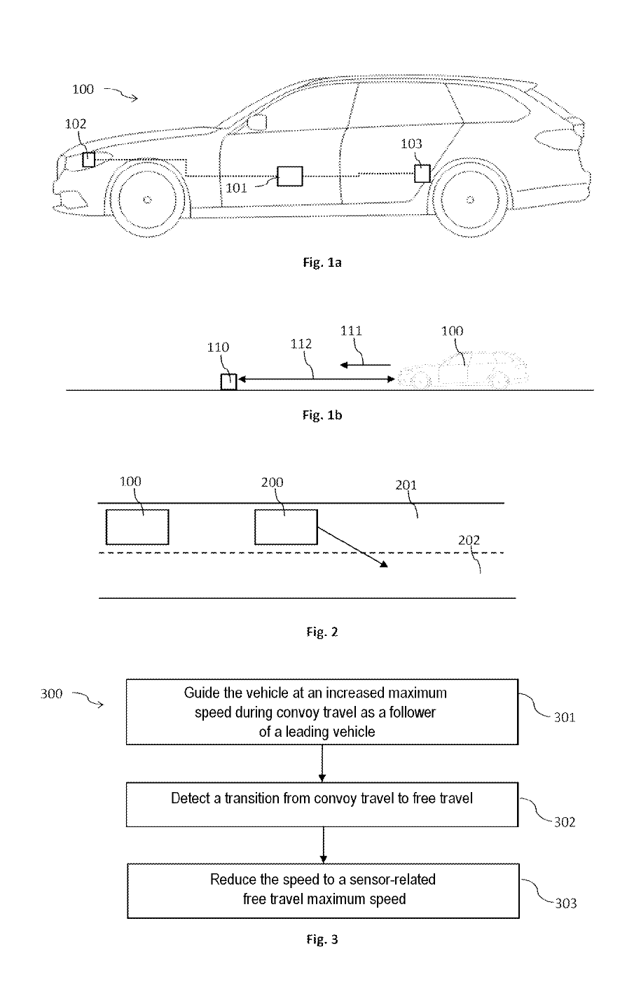

As stated at the outset, the present disclosure deals with enabling safe and reliable automated longitudinal guidance of a vehicle with the highest possible driving speed. In this context, FIG. 1a shows an exemplary vehicle 100 having one or more environmental sensors 102, each of which is configured to capture sensor data (which are also referred to as environment data) with respect to the environment of the vehicle 100. Examples of environmental sensors 102 are a camera, a radar sensor, a lidar sensor, an ultrasonic sensor, etc.

A (control) device 101 of the vehicle 100 can be configured to evaluate the environmental data, for example in order to detect one or more objects (e.g. other vehicles) in the environment of the vehicle 100. The device 101 may also be configured, based on the environmental data, in particular based on the one or more detected objects, to effect automated longitudinal and/or lateral guidance of the vehicle 100. For this purpose, one or more longitudinal and/or lateral guidance actuators 103 (e.g. a drive motor, a brake device and/or a steering device) of the vehicle can be controlled.

The automatic longitudinal guidance of the vehicle 100 can be effected, for example, by a speed and/or distance controller. During convoy travel in which the vehicle 100 follows a leading vehicle traveling directly in front of the vehicle 100, the actual distance between the vehicle 100 and the leading vehicle traveling directly in front of the vehicle 100 can be determined based on the environmental data. Furthermore, the actual distance can be adjusted, in particular regulated, to a predefined target distance by the distance controller. The driving speed of the vehicle 100 may correspond to the driving speed of the leading vehicle during convoy travel (at least on average over time).

The speed and/or distance controller may be configured to adjust, in particular regulate, the driving speed of the vehicle 100 to a predefined target speed during free travel in which no leading vehicle is arranged in front of the vehicle 100 (within a certain distance range). The predefined target speed can correspond to a certain maximum speed, and the maximum speed can depend on the quality of the environmental data captured by the one or more environmental sensors 102. In particular, the maximum speed can depend on the range with which objects arranged in front of the vehicle 100 in the direction of travel can be reliably detected based on the environmental data. The (sensor-related) maximum speed for free travel is also referred to in this document as the free travel maximum speed.

FIG. 1b shows an exemplary driving situation in which the vehicle 100 approaches a (stationary) object 110 arranged in front of the vehicle 100 in the direction of travel. The one or more environmental sensors 102 can be designed such that the object 110 can be reliably detected with a certain maximum distance A 112. The maximum distance A 112 can depend on the design of the one or more environmental sensors 102. Alternatively or additionally, the maximum distance A 112 can depend on the respective current ambient conditions in the surroundings of the vehicle 100. Examples of ambient conditions are:

a weather condition (such as sunshine, rain, fog, or snow); and/or

a lighting situation (such as daylight, night or twilight).

Taking into account a (relatively high) object deceleration (e.g. a maximum permissible deceleration) a of the vehicle 100 (e.g. a = -7 m/s²), the (sensor-related) maximum speed 111 of the vehicle 100 can be determined based on the maximum distance A 112, with the result that the vehicle 100 comes to a standstill, starting from the maximum speed 111 and in the presence of the maximum distance A 112, before reaching the (stationary) object 110 using the object deceleration a.

The sensor-related (free travel) maximum speed 111 can be relatively low depending on the design of the one or more environmental sensors 102 and the associated sensor range. This document describes one or more measures that can be used to increase the maximum speed of the vehicle 100, at least as a result of the situation. In particular, it can be made possible to increase the maximum speed during convoy travel of the vehicle 100 beyond the sensor-related (free travel) maximum speed 111.

FIG. 2 shows a driving situation in which the vehicle 100 drives in the first lane 201 of a multi-lane road behind a leading vehicle 200. The leading vehicle 200 may have a driving speed that is higher than the sensor-related free travel maximum speed 111. It can be assumed that the driving speed of the leading vehicle 200 is only so high that the leading vehicle 200 can still decelerate to a standstill without collision when using the object deceleration a after the detection of an object 110 ahead.

In the example shown in FIG. 2, the leading vehicle 200 changes to a second lane 202 of the multi-lane road, and so the vehicle 100 changes from convoy travel to free travel. The lane change of the leading vehicle 200 may take a certain transition period T. In other words, the transition from convoy travel to free travel of the vehicle 100 can take place in a certain transition period T. The transition period T may have been determined in advance by measurements (for typical lane change maneuvers). For example, the transition period T can be 1 second or more. The transition period T can be different for different types of transitions.

The transition period T can be used by the vehicle 100 to reduce the driving speed from a certain initial speed to the sensor-related free travel maximum speed 111. In order to reduce the driving speed, it is possible to use a certain transition deceleration b which is typically lower than the object deceleration a in terms of absolute value. For example, the transition deceleration b can be -2 m/s² (or less in terms of absolute value). Based on the transition period T and the transition deceleration b, it is possible to determine the speed delta which can be reduced during the transition from convoy travel to free travel. This speed delta can be added to the sensor-related free travel maximum speed 111, and thus results in an increased convoy travel maximum speed for convoy travel. In this way, it may be possible to guide the vehicle 100 longitudinally in an automated manner during convoy travel with a driving speed that exceeds the sensor-related free travel maximum speed 111.

By virtue of situation-adaptive and active adaptation of the driving strategy, the presence of a leading vehicle 200 can thus be exploited in such a way that it is possible to drive at a higher convoy travel maximum speed than the sensor-related free travel maximum speed 111. For this purpose, the device 101 of the vehicle 100 detects a change in convoy travel behind a leading vehicle 200 early and then initiates a deceleration of the vehicle 100 starting from the respective initial speed. The driving speed can be reduced in such a way that the reduced driving speed allows the vehicle 100 to still detect at an early stage an object 110 ahead in the lane 210 of the vehicle 100 at a free travel maximum speed 111 still sufficient for the sensors 102 (in order to avoid a collision with the object 110).

It is therefore possible to drive at an increased speed during convoy travel, which enables a continuous and relatively long highly automated journey without the vehicle 100 leaving its own safety area.

In a potentially critical example (e.g. in the event of relatively fast swerving of the leading vehicle 200 in order to avoid an object 110 in the lane 201 ahead), the speed of the vehicle 100 is initially reduced (during the transition period T) using the (relatively comfortable) transition deceleration. If, after the transition from convoy travel to free travel, the object 110 is detected based on the sensor data from the one or more environmental sensors 102 of the vehicle 100, it is possible to reliably cause, by effecting the object deceleration, the vehicle 100 to be decelerated to a standstill without collision before reaching the object 110.

Alternatively, the device 101 may be configured to copy the behavior of the leading vehicle 200. An automatic lane change to the second lane 202 can then be effected in order to avoid the (possibly present and/or not yet detected) object 110. Thus, in the event of a lane change of the leading vehicle 200 traveling in front, a corresponding automatic lane change of the vehicle 100 can be effected (provided that the neighboring lane 202 provides sufficient free space for this). For an evasive operation of the leading vehicle 200, the device 101 of the vehicle 100 can automatically copy this maneuver. Thus, the vehicle 100 may still remain in the safety slipstream of the leading vehicle 200, and a driving situation relevant to the design of the one or more environmental sensors 102 (in particular free travel with an object 110 ahead) can be avoided.

In one example, an environmental sensor (e.g. a lidar sensor) 102 of the vehicle 100 is designed to detect an object 110 (e.g. a pallet) with a maximum distance A 112 of 70 m. With a plausibility and/or reaction time of 1 s and a maximum (object) deceleration of -7 m/s², a free travel maximum speed 111 of 90 km/h can be enabled. The measures described in this document can enable an increased convoy travel maximum speed of e.g. 95 km/h during convoy travel behind a leading vehicle 200 (e.g. a truck). When the swerving of the leading vehicle 200 is detected, the vehicle 100 automatically reduces its driving speed to the free travel maximum speed 111 for free travel in order to ensure that the vehicle 100 can decelerate safely without collision when an object 110 is detected.

With an assumed lane change/evasion period (i.e. transition period) of 1 s of the leading vehicle 200, this transition period can be used to reduce the driving speed of the vehicle 100. If the free travel maximum speed 111 valid for the sensors 102 is 90 km/h, it is possible to decelerate for 1 s with a (comfortable) transition deceleration of -1.4 m/s² in order to reduce 1.4 m/s or a speed delta of 5.0 km/h.

FIG. 3 shows a flowchart of an exemplary (possibly computer-implemented) method 300 for the automated longitudinal guidance of a motor vehicle 100. The method 300 may be designed in particular to guide the motor vehicle 100 longitudinally in an automated manner with a degree of automation according to SAE level 3 or higher. The method 300 can be carried out by a (control) device 101 of the motor vehicle 100.

The method 300 comprises causing 301 the motor vehicle 100 to have a driving speed during convoy travel that is always equal to or less than a convoy travel maximum speed. Convoy travel may be present when the motor vehicle 100 has a leading vehicle 200 traveling in front (which travels directly in front of the motor vehicle 100 (in the same lane 201)) within a (predefined) convoy travel distance range ahead.

During convoy travel, it is possible to cause (by a distance controller) the motor vehicle 100 to have the driving speed of the leading vehicle 200, as long as the driving speed of the leading vehicle 200 is equal to or less than the convoy travel maximum speed. In addition, during convoy travel, it is possible to cause (by a speed controller) the motor vehicle 100 to have the convoy travel maximum speed, if the driving speed of the leading vehicle 200 is greater than the convoy travel maximum speed and if the leading vehicle 200 is still within the (predefined) convoy travel distance range.

The method 300 further comprises detecting 302 a transition of the motor vehicle 100 from convoy travel to free travel, wherein the motor vehicle 100 during free travel has no leading vehicle 200 traveling in front within the convoy travel distance range ahead. The transition from convoy travel to free travel can be effected in particular by the fact that the leading vehicle 200 changes to a neighboring lane 202. The transition from convoy travel to free travel can be detected based on the sensor data from the one or more environmental sensors 102.

The method 300 also comprises causing 303, in response to the detection 302, the driving speed of the motor vehicle 100 to be reduced, during the transition from convoy travel to free travel, to a driving speed equal to or less than a free travel maximum speed 111, the free travel maximum speed 111 being less than the convoy travel maximum speed. As explained further above, the free travel maximum speed 111 may depend on the design and/or the capture range of the one or more environmental sensors 102 of the motor vehicle 100. The convoy travel maximum speed can be (exactly) one speed delta above the free travel maximum speed 111, and the speed delta may depend in particular on the transition duration of the transition and/or on the transition deceleration effected during the transition.

The measures described in this document can enable an increased maximum driving speed for automated longitudinal guidance of a vehicle 100 in an efficient and safe manner, depending on the situation.

The present disclosure is not restricted to the exemplary embodiments that are shown. It should be noted in particular that the description and the figures are intended to illustrate the principle of the proposed methods, devices and systems only by way of example.

The foregoing disclosure has been set forth merely to illustrate the embodiments and is not intended to be limiting. Since modifications of the disclosed embodiments incorporating the spirit and substance of the present disclosure may occur to persons skilled in the art, the embodiments should be construed to include everything within the scope of the present disclosure and equivalents thereof.

What is claimed is:

1. A device for automated longitudinal guidance of a motor vehicle; wherein the device is configured to:
cause the motor vehicle to have a driving speed during convoy travel that is equal to or less than a convoy travel maximum speed, wherein the motor vehicle during convoy travel has a leading vehicle traveling in front within a convoy travel distance range ahead;
detect a transition of the motor vehicle from convoy travel to free travel, wherein the motor vehicle during free travel has no leading vehicle traveling in front within the convoy travel distance range ahead; and
cause, in response to detecting the transition from convoy travel to free travel, the driving speed of the motor vehicle to be reduced, during the transition from convoy travel to free travel, to a driving speed equal to or less than a free travel maximum speed, the free travel maximum speed being less than the convoy travel maximum speed.

2. The device according to claim 1, wherein:
the convoy travel maximum speed is greater than the free travel maximum speed by a speed delta, and
the speed delta is based on
a transition duration for the transition of the motor vehicle from convoy travel to free travel, and/or
a transition deceleration with which the motor vehicle is decelerated during the transition from convoy travel to free travel.

3. The device according to claim 1, wherein the free travel maximum speed is dependent on a range with which an object ahead can be detected based on sensor data from one or more environmental sensors of the motor vehicle.

4. The device according to claim 1, wherein the device is configured to:
determine one or more current ambient conditions in surroundings of the motor vehicle that influence a range with which an object ahead can be detected based on sensor data from one or more environmental sensors of the motor vehicle; and
determine the free travel maximum speed and/or the convoy travel maximum speed based on the one or more ambient conditions.

5. The device according to claim 4, wherein the one or more ambient conditions comprise:
a weather condition in the surroundings of the motor vehicle, and/or
a lighting situation in the surroundings of the motor vehicle.

6. The device according to claim 1, wherein the device is configured to:
detect an object ahead during free travel;
cause, in response to detecting the object, the motor vehicle to be decelerated at least temporarily with an object deceleration; and
reduce the driving speed during the transition from convoy travel to free travel with a deceleration that is equal to or less than a transition deceleration, wherein an absolute value of the transition deceleration is less than the object deceleration.

7. The device according to claim 6, wherein the absolute value of the transition deceleration is less than the object deceleration by a factor of 2 or more.

8. The device according to claim 1, wherein the device is configured to:
select a transition type of the transition from convoy travel to free travel from a multiplicity of different transition types; and
determine a speed delta with which the convoy travel maximum speed exceeds the free travel maximum speed based on the selected transition type.

9. The device according to claim 8, wherein the multiplicity of different transition types comprises:
one or more transition types for a lane change of the leading vehicle to a neighboring lane, and/or
one or more transition types for a turning maneuver of the leading vehicle, and/or
a transition type in which the leading vehicle leaves the convoy travel distance range based on having a driving speed greater than the convoy travel maximum speed and on a distance between the motor vehicle and the leading vehicle increasing.

10. The device according to claim 9, wherein the one or more transition types for the lane change of the leading vehicle to the neighboring lane each comprise a transition type for a lane change of an automobile traveling in front, a truck traveling in front, a motorcycle traveling in front, and/or a bus traveling in front.

11. The device according to claim 1, wherein the device is configured to:
determine a vehicle type of the leading vehicle from a multiplicity of different vehicle types; and
determine a speed delta with which the convoy travel maximum speed exceeds the free travel maximum speed based on the determined vehicle type of the leading vehicle.

12. The device according to claim 1, wherein the device is configured, during convoy travel, to:
cause the motor vehicle to be guided longitudinally in an automated manner with a target distance behind the leading vehicle, using a distance controller, as long as the driving speed of the leading vehicle is equal to or less than the convoy travel maximum speed; and
cause the driving speed of the motor vehicle to be equal to or less than the convoy travel maximum speed, using a speed controller, if the leading vehicle has a driving speed greater than the convoy travel maximum speed.

13. The device according to claim 1, wherein the device is configured to:
cause the driving speed of the motor vehicle to be reduced, using a speed controller, during a transition period of the transition from convoy travel to free travel, from an initial speed exceeding the free travel maximum speed to the free travel maximum speed; and
cause the driving speed of the motor vehicle to be equal to or less than the free travel maximum speed during subsequent free travel, using the speed controller.

14. A method for automated longitudinal guidance a motor vehicle, wherein the method comprises:
causing the motor vehicle to have a driving speed during convoy travel that is equal to or less than a convoy travel maximum speed, wherein the motor vehicle during convoy travel has a leading vehicle traveling in front within a convoy travel distance range ahead;
detecting a transition of the motor vehicle from convoy travel to free travel, wherein the motor vehicle during free travel has no leading vehicle traveling in front within the convoy travel distance range ahead; and
causing, in response to the detection, the driving speed of the motor vehicle to be reduced, during the transition from convoy travel to free travel, to a driving speed equal to or less than a free travel maximum speed, the free travel maximum speed being less than the convoy travel maximum speed.

15. The method according to claim 14, wherein:
the convoy travel maximum speed is greater than the free travel maximum speed by a speed delta, and
the speed delta is based on
a transition duration for the transition of the motor vehicle from convoy travel to free travel, and/or
a transition deceleration with which the motor vehicle is decelerated during the transition from convoy travel to free travel.

16. The method according to claim 14, wherein the free travel maximum speed is dependent on a range with which an object ahead can be detected based on sensor data from one or more environmental sensors of the motor vehicle.

17. The method according to claim 14, further comprising:
determining one or more current ambient conditions in surroundings of the motor vehicle that influence a range with which an object ahead can be detected based on sensor data from one or more environmental sensors of the motor vehicle; and
determine the free travel maximum speed and/or the convoy travel maximum speed based on the one or more ambient conditions.

18. The method according to claim 17, wherein the one or more ambient conditions comprise:
a weather condition in the surroundings of the motor vehicle, and/or
a lighting situation in the surroundings of the motor vehicle.

19. The method according to claim 14, further comprising:
detecting an object ahead during free travel;
causing, in response to detecting the object, the motor vehicle to be decelerated at least temporarily with an object deceleration; and
reducing the driving speed during the transition from convoy travel to free travel with a deceleration that is equal to or less than a transition deceleration, wherein an absolute value of the transition deceleration is less than the object deceleration.

20. The method according to claim 19, wherein the absolute value of the transition deceleration is less than the object deceleration by a factor of 2 or more.
